(19) United States
(12) Patent Application Publication
(10) Pub. No.: US 2005/0121570 A1
(43) Pub. Date: Jun. 9, 2005

(54) Quick set device for mounting electrical devices

(76) Inventor: Thomas A. Whorley, Mineral Wells, TX (US)

Correspondence Address: MILES & STOCKBRIDGE PC, 1751 PINNACLE DRIVE, SUITE 500, MCLEAN, VA, 22102-3833, US

(21) Appl. No.: 10/946,327

(22) Filed: Sep. 22, 2004

Related U.S. Application Data
(60) Provisional application No. 60/504,203, filed on Sep. 22, 2003.

(51) Int. Cl. G06F 1/16

(52) U.S. Cl. 248/205.1; 361/683

(57) ABSTRACT

The present invention is directed to a quick set device for mounting electrical devices in a flush mount device box and method for making the devices. The quick set device comprises a clip constructed to hold in place a mounting screw adapted to fasten an electrical device such as an outlet or switch to be mounted to a mount box. The quick set device allows an installer to “push” the mounting screw into a mounting hold. The ability to push the mounting screw into the hole obviates the need to screw all the threads to complete the installation. The quick set device incorporates two engagement tabs which serve to increase the contact area between the screw and the device engagement tabs thereby spreading out the force being applied to the screw. A radius is cut in the nose of an engagement tab on the device, wherein the radius is designed to match the root diameter of a mounting screw. Clips are made by running a ribbon of material through a stamp that partially cuts the part out of the material. The partially stamped clips stays on the ribbon that is placed on a reel. The reel may then be fed into an assembly machine for inserting the clips into plastic boxes at a rate of at least one per second. The assembly machine breaks the clip off of the reel. The ribbon (and thus the clip) is preferably made of pre-plated or non-corrosive material such as Stainless Steel or Beryllium-Copper.

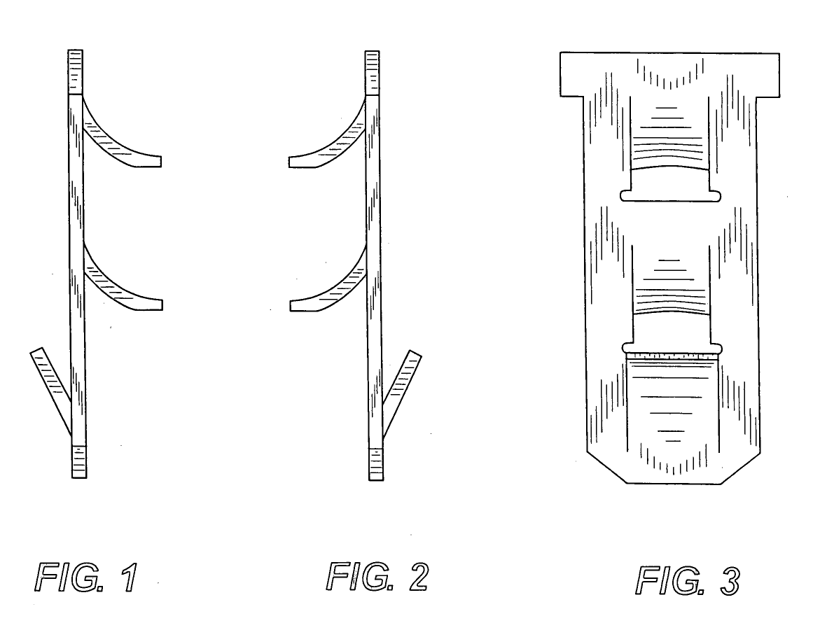

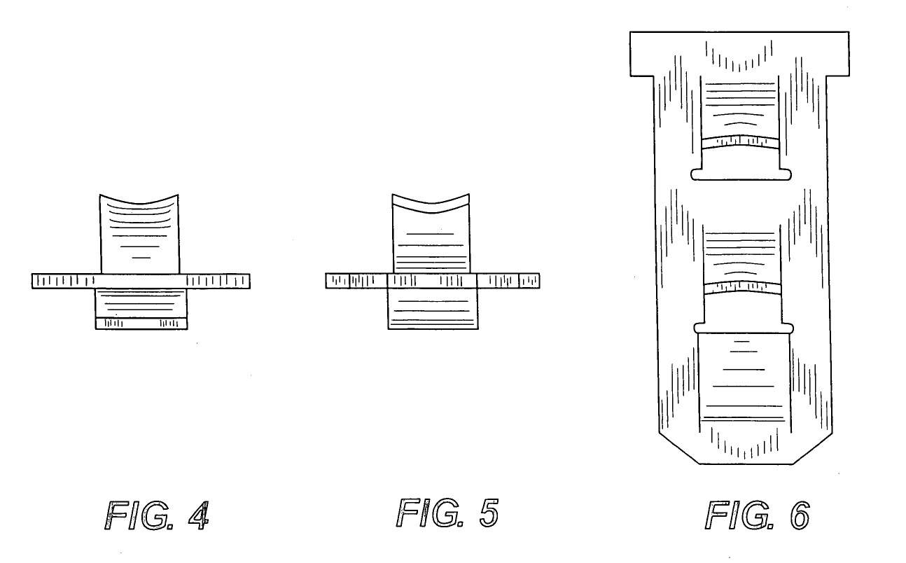

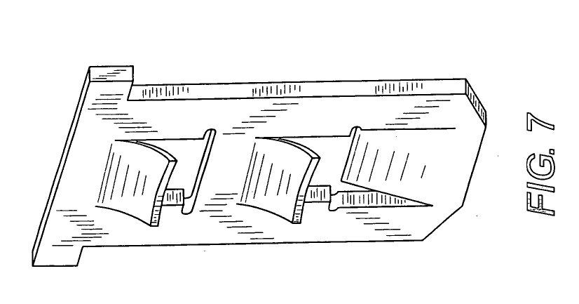

### CROSS REFERENCE TO RELATED APPLICATION

This application claims the benefit of U.S. provisional patent application 60/504,203 filed Sep. 22, 2003.

### BACKGROUND OF THE INVENTION

The present invention is directed to a quick set device for mounting electrical devices in a flush mount device box. The inventive device is a clip that holds in place the mounting screw that fastens the electrical device to be mounted to a mount box. The inventive device allows the installer to 37 push” the mounting screw into the hole. The ability to push the mounting screw into the hole obviates the need to screw all the threads to complete the installation.

While other devices have been developed to perform similar functions, known devices frequently strip threads from the mounting screw, thereby resulting in a loose and unsafe installation.

The present inventive device alleviates these types of problems by increasing the contact area between the screw and the device engagement tab. In one embodiment, the inventive device increases the contact area by including two engagement tabs, thereby spreading out the force being applied to the screw. In another embodiment, a radius is cut in the nose of an engagement tab on the device, wherein the radius is designed to match the root diameter of a mounting screw.

The inventive device provides for quick mounting of outlet and switches in flush device wall boxes. The device includes an engagement mechanism that allows the mounting screw to be held in place in the wall box. This engagement mechanism allows the mounting screw to be pushed into the mounting hole rather than having to manually twist the screw the full length of the threads, thereby saving installation personnel time. The engagement mechanism together with mounting screw holds the device in the box preventing wiring from being exposed.

The increased contact area between the inventive device and the screw prevents thread damage that would render the screw incapable of being removed with a reverse twist of a screwdriver. In particular, it prevents threads from being stripped from the mounting screw during a sudden pull from the outside. The two tab embodiment allows a thinner material to be used, resulting in less insertion force being required to seat the mounting screw.

### DESCRIPTION OF THE DRAWINGS

Additional details about various embodiments of the inventive device are shown in the attached appendices.

As shown in the drawings in Appendix A, preferred embodiments of the inventive device provide for multiple prongs or tabs. As shown in the attached drawings, a preferred configuration provides for two top tabs extending to a first side of the device, and a single lower tab extending to the opposite side of the device. The device may be cut from a single sheet of metal and may be formed by bending certain portions at various angles not to exceed about forty-five degrees.

In one embodiment of the invention, the clips are made by running a ribbon of material through a stamp that partially cuts the part out of the material. The partially stamped clips stays on the ribbon that is placed on a reel. The reel may be fed into an assembly machine for inserting the clips into plastic boxes at a rate of at least one per second. The assembly machine breaks the clip off of the reel. In this embodiment, the ribbon (and thus the clip) is preferably made of pre-plated or non-corrosive material such as Stainless Steel or Beryllium-Copper. No heat treating or zinc coating is necessary in this embodiment.

In a test performed on the clip as described above, a screw is inserted in the clip and removed three different times. With the same screw, a fifty pound static load is then attached to a screw in the clip and held for five minutes, and then a one pound hammer slides along an eighteen inch track coming to rest on a 2 pound stop plate with the entire assembly being attached to the screw, with a maximum allowance of screw movement consistently being less than 0.094 inches.

Plastic ridges may optionally be added to a plastic box inside the screw hole for attachment of the clip and screw. The ridges are made by filling in grooves of an insert for an injection mold. The grooves are preferably about 0.005 inches high and help resist slippage by contacting threads of the screw. The ridges add stability to the clip even beyond the stability shown in the test mentioned above. The ridges significantly help to resist slippage over the small allowance window of 0.094 inches.

The inventive device may be heat-treated and zinc-coated in another embodiment. This method of manufacture in addition to the unique tab configuration ensures the ability of the device to support a large amount of weight. As shown by the Underwriters Laboratories (UL) notice of authorization in Appendix B, the inventive device has been certified as meetings UL standards. The UL standards are detailed in Appendix C. Thus, a light weight clip pressed from a single sheet of metal provides a minimum retaining force of 50 pounds for a size 6 screw, 100 pounds for a size 8 screw, and 200 pounds for a size 10 screw.

While this invention has been described in conjunction with specific embodiments thereof, many alternatives, modifications and variations will be apparent to those skilled in the art. Accordingly, the preferred embodiments of the invention as set forth herein, are intended to be illustrative, not limiting. Various changes may be made without departing from the true spirit and full scope of the invention as set forth herein.

1. A quick set device for mounting electrical devices in a flush mount box comprising a clip adapted to hold in place a mounting screw that fastens an electrical device to be mounted to the mount box, the clip having at least one hole to allow an installer to “push” a mounting screw into the hole.

2. The device of claim 1 further including means for increasing the contact area between the screw and at least one engagement tab on the clip.

3. The device of claim 2 including two engagement tabs for spreading out the force applied to the screw.

4. The device of claim 2 wherein a radius is cut in a nose of the engagement tab.

5. The device of claim 4 wherein the radius matches the root diameter of a mounting screw.

6. A method for making clips comprising running a ribbon of material through a stamp, stamping the ribbon to partially cut out of the ribbon certain material, while retaining the partially stamped clips on the ribbon, winding the ribbon on a reel, then feeding the reel into an assembly machine for detaching and inserting the clips into plastic boxes.

7. The invention as set forth in claim 6 further including breaking the clip off the reel.

8. The invention as set forth in claim 6 wherein the reel is fed into the assembly machine at a rate of at least one clip per second.
